(19) United States
(12) Patent Application Publication
(10) Pub. No.: US 2026/0099287 A1
(43) Pub. Date: Apr. 9, 2026

(54) STORAGE MEDIUM, INFORMATION PROCESSING METHOD, AND INFORMATION PROCESSING APPARATUS

(71) Applicant: CANON KABUSHIKI KAISHA, Tokyo (JP)

(72) Inventors: HIROFUMI MOCHIZUKI, Saitama (JP); KOHEI TODA, Kanagawa (JP)

(21) Appl. No.: 19/351,022

(22) Filed: Oct. 6, 2025

(30) Foreign Application Priority Data
Oct. 8, 2024 (JP) 2024-176791

(51) Int. Cl. G06F 3/12

(52) U.S. Cl. CPC G06F 3/1273; G06F 3/1205; G06F 3/1208

(57) ABSTRACT

A method includes displaying a first image in a first display area, the first image being generated based on a first prompt input by a user and an image of input image data, displaying histories associated with the first image in a second display area, in a state where a second image generated based on a second prompt input by the user and the generated first image is displayed in the first display area, and transmitting print data including image data of an image displayed in the first display area to a printing apparatus by accepting a printing instruction, wherein the first image is displayed in the first display area, when a history associated with the first image is selected from the displayed histories in a state where the second image is displayed in the first display area.

### BACKGROUND

### Field of the Technology

The present disclosure relates to a storage medium, an information processing method, and an information processing apparatus.

### DESCRIPTION OF THE RELATED ART

In recent years, development of conversational artificial intelligence (AI) such as a chatbot or generative AI has progressed rapidly. In connection with the development, various services using the conversational AI have been provided. Japanese Patent Laid-Open No. 2024-25293 describes a system which displays an image and edits the image based on a prompt input by a user.

When editing work is repeatedly performed on an input image based on a prompt input by the user in order to generate or edit an image to be printed, there is a case where the user would like to restore the image to the image edited at a certain time point. In this case, it is quite troublesome to repeatedly input the same prompt for that purpose.

### SUMMARY

The present disclosure is directed to a technique for reducing time and effort necessary to restore an image to an image edited at a certain time point in a case where editing work is repeatedly performed on the input image based on a prompt input by the user.

According to an aspect of the present disclosure, a non-transitory computer readable storage medium stores a program for causing an information processing apparatus to perform a method, the method including displaying a first image in a first display area, the first image being generated based on a first prompt input by a user and an image of input image data, displaying histories associated with the first image in a second display area, in a state where a second image generated based on a second prompt input by the user and the generated first image is displayed in the first display area, and transmitting print data including image data of an image displayed in the first display area to a printing apparatus via print data transmission by accepting a printing instruction, wherein the first image is displayed in the first display area, when a history associated with the first image is selected from the displayed histories in a state where the second image is displayed in the first display area.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of a general configuration of the present system.

FIG. 2 is a block diagram illustrating an example of a hardware configuration of a computer in the present system.

FIG. 3 is a block diagram illustrating an example of a hardware configuration of a generative artificial intelligence (AI) server in the present system.

FIG. 4 is a block diagram illustrating an example of a hardware configuration of a printer in the present system.

FIG. 5 is a block diagram illustrating an example of a software configuration of the present system.

FIG. 6 is a diagram illustrating an example of a screen of a printing application in the present system.

FIG. 7 is a diagram illustrating an example of a history display screen of the printing application in the present system.

FIG. 8 is a table illustrating an example of a structure of history data in the present system.

FIG. 9A and 9B are a diagram illustrating examples of a setting screen of the printing application in the present system.

FIGS. 10A and 10B are a sequence diagram illustrating an example of processing for executing image conversion through chatting and executing printing.

FIG. 11 is a sequence diagram illustrating an example of processing for displaying and applying history data.

FIG. 12 is a flowchart illustrating an example of processing executed by the printing application.

FIG. 13 is a flowchart illustrating an example of processing executed by a generative artificial intelligence (AI) server.

FIG. 14 is a flowchart illustrating an example of processing executed by the printing application.

FIG. 15 is a flowchart illustrating an example of processing executed by the printing application.

FIG. 16 is a diagram illustrating an example of a timeline display screen of the printing application.

FIG. 17 is a table illustrating an example of a structure of timeline data.

FIG. 18 is a flowchart illustrating examples of processing for displaying a timeline and processing for restoring print data to a certain time point executed by the printing application.

### DESCRIPTION OF THE EMBODIMENTS

Hereinafter, embodiments are described in detail with reference to the appended drawings. The below-described embodiments are not intended to limit the present disclosure according to the scope of the appended claims. Although a plurality of features is described in the embodiments, not all of the features are essentially required for the present disclosure, and the plurality of features may be combined optionally. Further, in the appended drawings, the same reference numerals are applied to constituent elements identical or similar to each other, and duplicative descriptions thereof are omitted.

### System Configuration

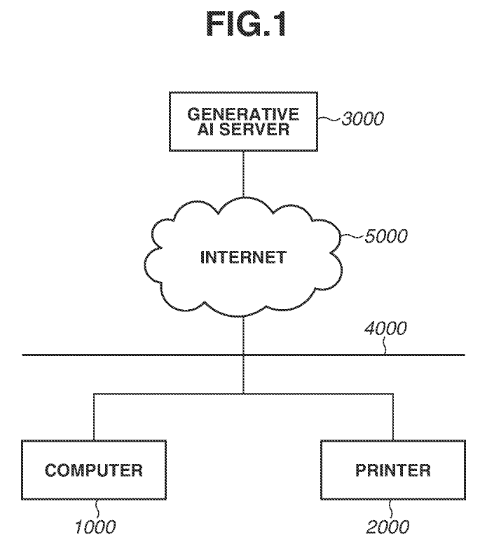

First, a network configuration of a printing system according to the present embodiment is described below with reference to FIG. 1.

As illustrated in FIG. 1, the present printing system includes a computer 1000 as a terminal apparatus or an information processing apparatus, a printer 2000 as one example of a printing apparatus, and a generative artificial intelligence (AI) server 3000.

For example, the computer 1000 and the printer 2000 are installed in the office, and communicably connected to each other via a cooperate network 4000. The cooperate network 4000 is connected to an external internet 5000 via a router (not illustrated). Herein, the computer 1000 is one example of a user terminal or an information processing apparatus, and the generative AI server 3000 is one example of a server apparatus.

The generative AI server 3000 is communicably connected to the computer 1000 and the printer 2000 via the internet 5000 and the cooperate network 4000. Herein, generative AI is AI capable of newly generating content such as text, an image, a moving image, and a sound based on a prompt and data input by a user. The generative AI is repeatedly trained by a technique called "deep learning", and outputs a reply based on a result of the training.

### Hardware Configuration

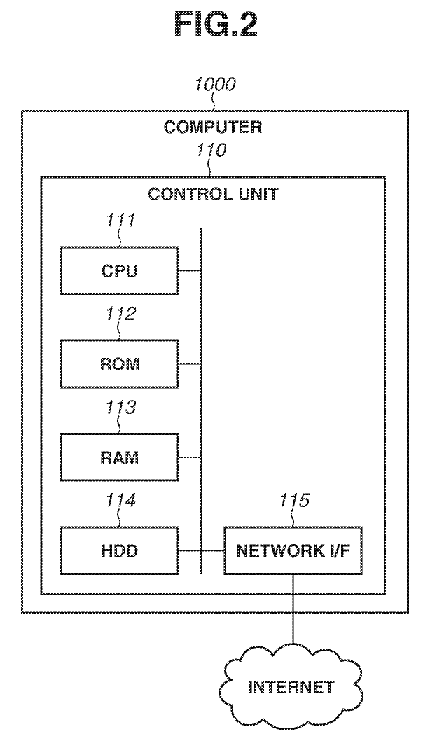

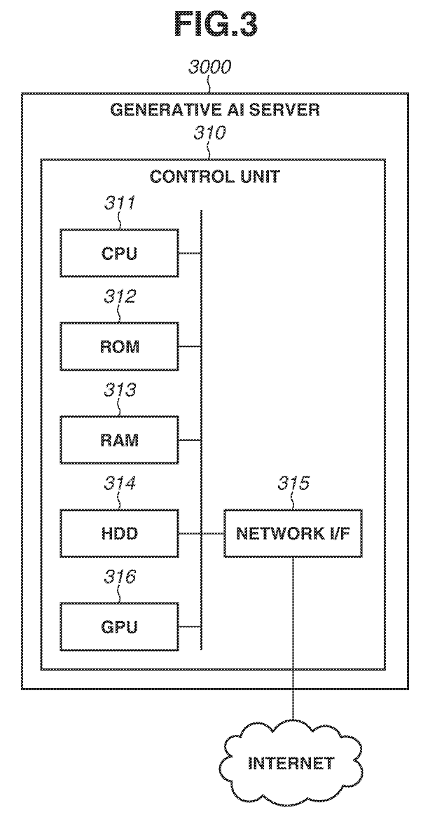

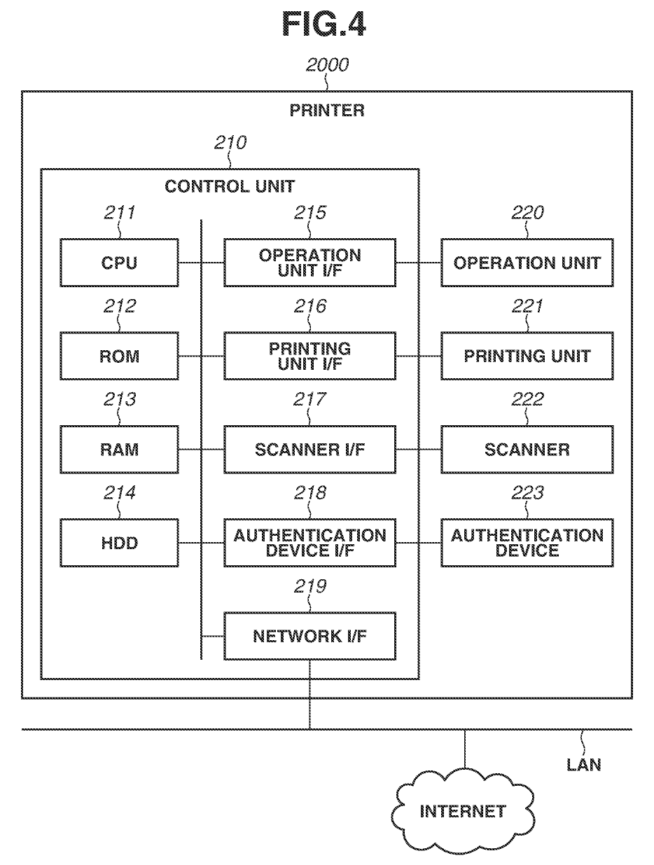

Hardware configurations of the apparatuses included in the printing system according to the present embodiment are described with reference to FIGS. 2 to 4. FIG. 2 is a block diagram illustrating an example of the hardware configuration of the computer 1000. FIG. 3 is a block diagram illustrating an example of the hardware configuration of the generative AI server 3000. FIG. 4 is a block diagram illustrating an example of the hardware configuration of the printer 2000.

As illustrated in FIG. 2, the computer 1000 includes a central processing unit (CPU) 111, a read only memory (ROM) 112, a random access memory (RAM) 113, a hard disk drive (HDD) 114, and a network interface (I/F) 115. The computer 1000 further includes a display unit (not illustrated) and an operation unit (not illustrated). The CPU 111 controls a general operation by reading a control program stored in the ROM 112 and executing various types of processing. The RAM 113 is used as a main memory and a temporary storage area such as a working area of the CPU 111. The HDD 114 is a large-capacity storage unit for storing image data and various programs. The network I/F 115 is an interface for connecting the computer 1000 to the internet. The computer 1000 receives processing requests from the other apparatus and a service, and transmits and receives various types of information via the network I/F 115.

The display unit is a display device such as a monitor. The display unit may be integrated with the computer 1000 or may be connected to the computer 1000 as an external device. Image information output by the CPU 111 is displayed on the display unit.

The operation unit is an input device such as a keyboard or a mouse. The operation unit may be integrated with the computer 1000 or may be connected to the computer 1000 as an external device. The CPU 111 accepts various operations from the user via the operation unit.

A CPU 311, a ROM 312, a RAM 313, an HDD 314, and a network I/F 315 included in the generative AI server 3000 in FIG. 3 are similar to the CPU 111, the ROM 112, the RAM 113, the HDD 114, and the network I/F 115 included in the computer 1000. Therefore, in the present embodiment, description of the hardware configuration of the generative AI server 3000 is omitted. In addition, a graphics processing unit (GPU) 316 can be included in the generative AI server 3000.

The printer 2000 in FIG. 4 includes a control unit 210, an operation unit 220, a printing unit 221, a scanner 222, and an authentication device 223. The control unit 210 controls a general operation of the printer 2000. The CPU 211 reads a control program stored in the ROM 212, and executes and controls various functions included in the printer 2000, such as scanning, printing, and communication functions. The RAM 213 is used as a main memory and a temporary storage area such as a working area of the CPU 211. In the present embodiment, the one CPU 211 executes the processing illustrated in the below-described flowcharts by using one memory, i.e., the RAM 213 or the HDD 214. However, the present embodiment is not limited thereto.

For example, a plurality of CPUs and a plurality of RAMs or HDDs may cooperatively execute the processing. The HDD 214 is a large-capacity storage unit for storing image data and various programs. An operation unit I/F 215 is an interface for connecting the operation unit 220 to the control unit 210. The operation unit 220 includes a touch panel and a keyboard, and accepts an operation, an input, and an instruction from the user. A printing unit I/F 216 is an interface for connecting the printing unit 221 to the control unit 210. Image data used for printing is transmitted to the printing unit 221 from the control unit 210 via the printing unit I/F 216, and printed on a recording medium such as a sheet of paper. A scanner I/F 217 is an interface for connecting the scanner 222 to the control unit 210. The scanner 222 generates image data by reading a document placed on a document positioning plate or an auto document feeder (ADF) (not illustrated), and inputs the image data to the control unit 210 via the scanner I/F 217. The printer 2000 can print and output (i.e., copy) the image data generated by the scanner 222 from the printing unit 221, and can also transmit the image data through file transmission or mail transmission. An authentication device I/F 218 is an interface for connecting the authentication device 223 to the control unit 210. For example, the authentication device 223 is a card reader for reading an integrated circuit (IC) card or a fingerprint authentication device for reading a fingerprint. The authentication device 223 is used when the user performs authentication in order to use the printer 2000. A network I/F 219 is an interface for connecting the control unit 210 (printer 2000) to a local area network (LAN). The printer 2000 transmits image data and information to the services on the internet and receives various types of information therefrom via the network I/F 219.

### Software Configuration

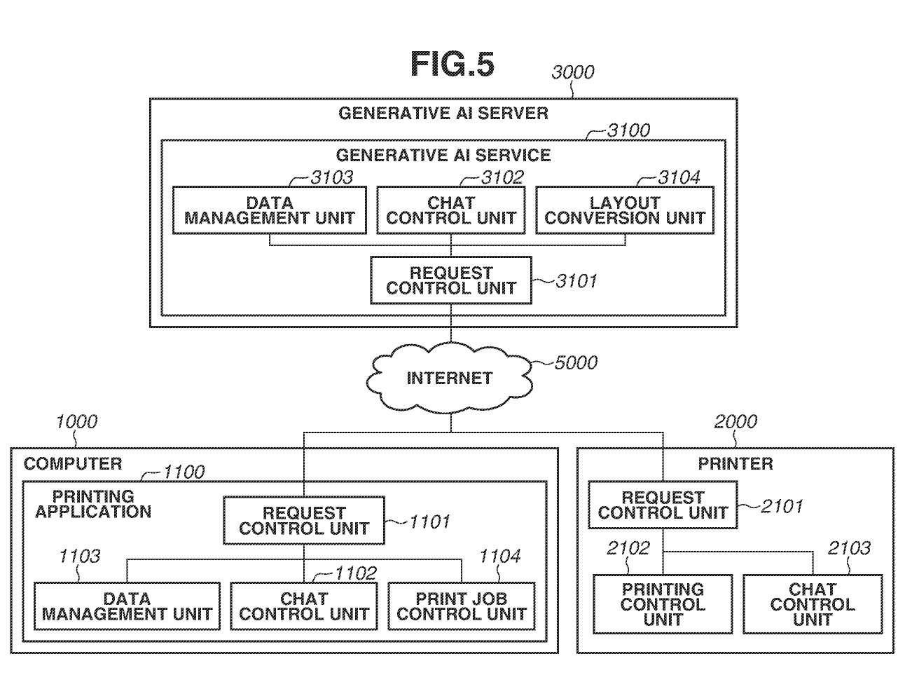

Software configurations of the apparatuses included in the printing system according to the present embodiment are described with reference to FIG. 5. As illustrated in FIG. 5, a printing application 1100 is installed in the computer 1000. The printing application 1100 is an application for instructing the printer 2000 to execute printing. The printing application 1100 displays a preview of an image to be printed, accepts a print setting, and transmits a print job to the printer 2000. In other words, the printing application 1100 is capable of displaying an image and accepting a setting. The printing application 1100 can be an independent application or an application integrated with a printer driver embedded in the operating system (OS).

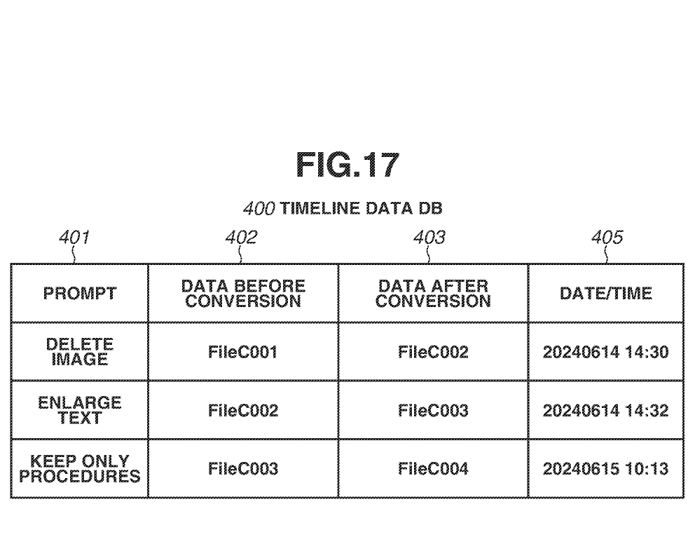

The printing application 1100 includes a request control unit 1101, a chat control unit 1102, a data management unit 1103, and a print job control unit 1104. The request control unit 1101 stands ready to receive requests from the computer 1000, the printer 2000, and the generative AI server 3000, and causes the units included in the printing application 1100 to execute processing according to the requests. The chat control unit 1102 transmits a prompt (i.e., text describing an instruction) input by the user and print data to the generative AI server 3000. Further, the chat control unit 1102 displays data received from the generative AI server 3000. The data management unit 1103 manages data used by the printing application 1100. For example, a prompt input to the chat control unit 1102, print data before conversion which is to be transmitted to the generative AI service 3100, and print data after conversion which is received from the generative AI service 3100 are data to be managed, and the data management unit 1103 saves and manages the above-described data as timeline data. An example of the timeline data to be saved is described below in FIG. 17. Further, an application setting used by the printing application 1100 is also saved by the data management unit 1103. The print job control unit 1104 converts print data generated by the printing application 1100 and the generative AI server 3000 into data in a format printable by the printer 2000, and transmits to the printer 2000 the converted data as a print job. In addition, the print data can be a data in a format directly printable by the printer 2000 without being converted by the print job control unit 1104.

The printer 2000 includes a request control unit 2101, a printing control unit 2102, and a chat control unit 2103. The request control unit 2101 stands ready to receive requests from the computer 1000, the printer 2000, and the generative AI server 3000. The printing control unit 2102 executes a print job received from the computer 1000. The received print job may be executed promptly, or printing of the print job may be held until a printing instruction is received from the user via the operation unit 220 and then performed. The chat control unit 2103 transmits a prompt and print data input by the user to the generative AI server 3000. Further, the chat control unit 2103 displays data received from the generative AI server 3000.

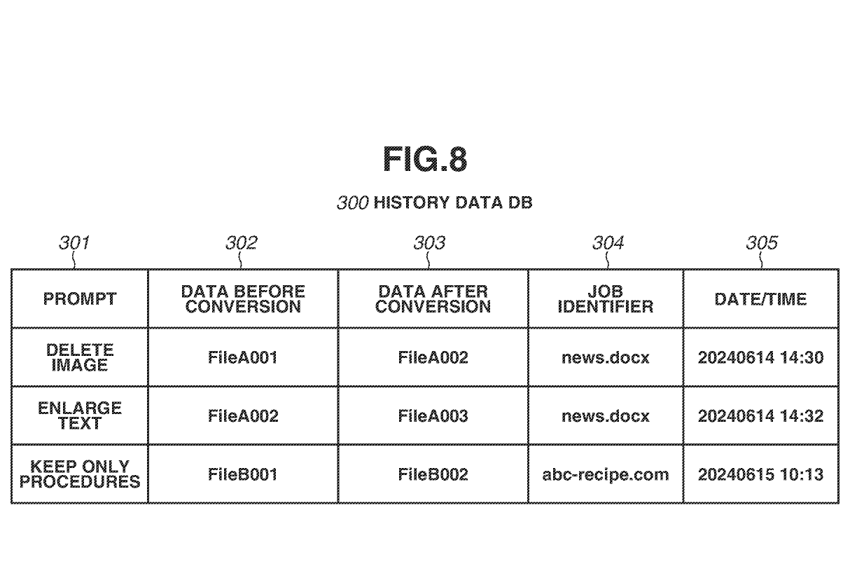

The generative AI server 3000 includes the generative AI service 3100. The generative AI service 3100 includes a request control unit 3101, a chat control unit 3102, a data management unit 3103, and a layout conversion unit 3104. The generative AI service 3100 is a server having a generative AI interpretation processing function and a print data layout modification function. The request control unit 3101 stands ready to receive requests from the computer 1000, the printer 2000, and the generative AI server 3000, and causes the units included in the generative AI service 3100 to execute processing according to the requests. The chat control unit 3102 has a generative AI interpretation processing function. The chat control unit 3102 interprets a received prompt described in natural language and print data, and determines a response to the received prompt and layout conversion processing to be executed on the print data. The layout conversion unit 3104 receives the layout conversion processing on the print data interpreted by the chat control unit 3102, and executes the layout conversion processing. In the present embodiment, the chat control unit 3102 and the layout conversion unit 3104 are described as different processing units. However, the chat control unit 3102 and the layout conversion unit 3104 can be collectively configured as one conversion processing unit. The data management unit 3103 stores and manages the received prompt, the received print data, and the converted print data as a history in association with information which specifies instructed user information. An example of the history data saved in the above is described below in FIG. 8.

### Example of Printing Application Screen

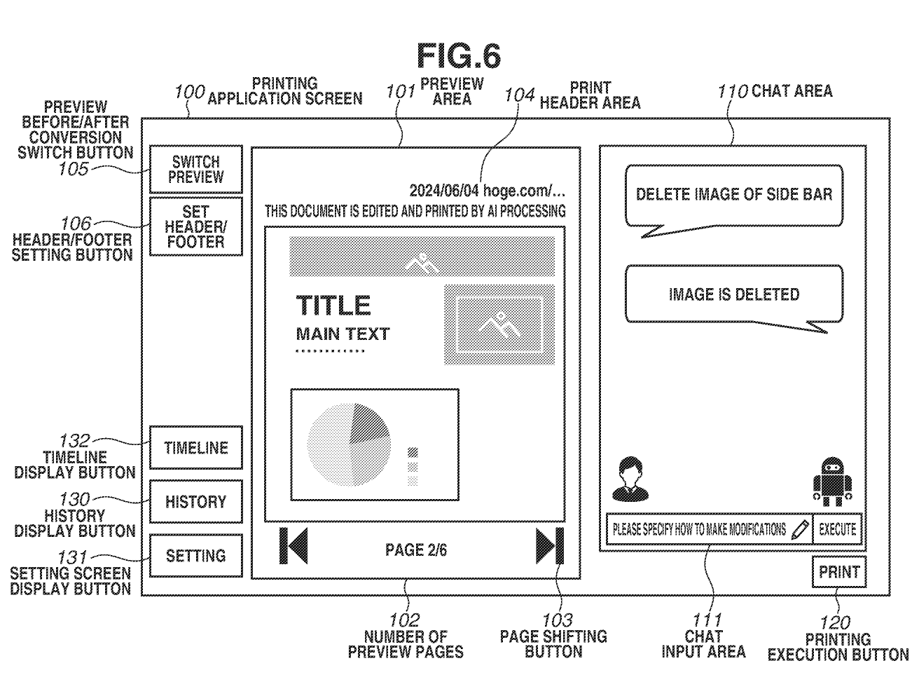

An example of a printing application screen 100 is described with reference to FIG. 6. The printing application screen 100 includes a preview area 101, a chat area 110, and other objects. The printing application screen 100 is displayed on the display unit of the computer 1000.

The preview area 101 is an area where an image of image data to be transmitted to the printer 2000 from the printing application 1100 is displayed as a preview image. Through the preview image, the user can previously check printed matter to be printed by the printer 2000 before the printed matter is output. The chat area 110 accepts an input of a prompt described in natural language from the user and displays the prompt. The preview area 101 and the chat area 110 update the display every time a response from the generative AI server 3000 is received.

In the present embodiment, first, a print preview of image data input by the user or a print preview of image data input from a web site specified by the user is displayed in the preview area 101. A prompt in natural language, which is input by the user in order to edit the print data, is accepted in the chat area 110. Every time print data generated by the generative AI server 3000 based on the input prompt and the original data is received, print data displayed in the preview area 101 is updated with the received print data.

The preview area 101 includes the number of preview pages 102, a page shifting button 103, a print header area 104, a preview before/after conversion switch button 105, and a header/footer setting button 106. The number of preview pages 102 indicates a total number of pages when the current displayed print data (image data) is printed and a page number of the page currently displayed in the preview area 101. A preview displayed in the preview area 101 is changed by shifting the currently-displayed page to the previous page or the next page by operating the page shifting button 103. A preview of a header printed at the time of printing the print data is displayed in the print header area 104. This header may be included in the print data, or may be displayed only when preview images are displayed. In other words, the information included in the print header area 104 may or may not be printed.

A printed date/time and a printing target name such as a file name of a printing target or a uniform resource locator (URL) where the image data as a printing target is acquired can be included in the header. Further, in a case where the print data is generated by the generative AI service 3100, information indicating that generative AI is used to generate the print data is included in the header when the print data is displayed in the preview area 101. For example, character strings such as "This document is edited and printed by AI processing" and "This is an image generated by generative AI" may be displayed in the print header area 104, and these character strings may be printed. The information indicating that generative AI is used to generate the print data may be displayed and printed in a print footer area or other blank space, or may be displayed and printed so as to be included in the image of the image data, instead of in the print header area 104. When the preview before/after conversion switch button 105 is pressed, a preview image displayed in the preview area 101 is switched between a current preview image and an unedited preview image which is received when the printing application 1100 is activated. Further, display of the number of preview pages 102 is also switched simultaneously. At this time, the preview is displayed on the printing application screen 100 in a state where the user can distinguish between the initial preview and the latest preview. Further, when the preview before/after conversion switch button 105 is pressed, a screen displaying only the latest preview and a screen displaying the unedited preview and the latest preview side-by-side may be switched.

The chat area 110 includes a chat input area 111. An instruction to convert the print data, input by the user in natural language, is accepted via the chat input area 111. The printing application 1100 transmits the accepted instruction for converting the print data to the generative AI service 3100 together with the print data. The printing application 1100 receives a character string describing a conversion result from the generative AI service 3100, and displays the character string in the chat area 110 as a chat response. In the chat area 110 in FIG. 6, text describing an instruction, "Delete an image of the side bar", is input in Japanese, and a conversion result describing that the image is deleted successfully is displayed as a response.

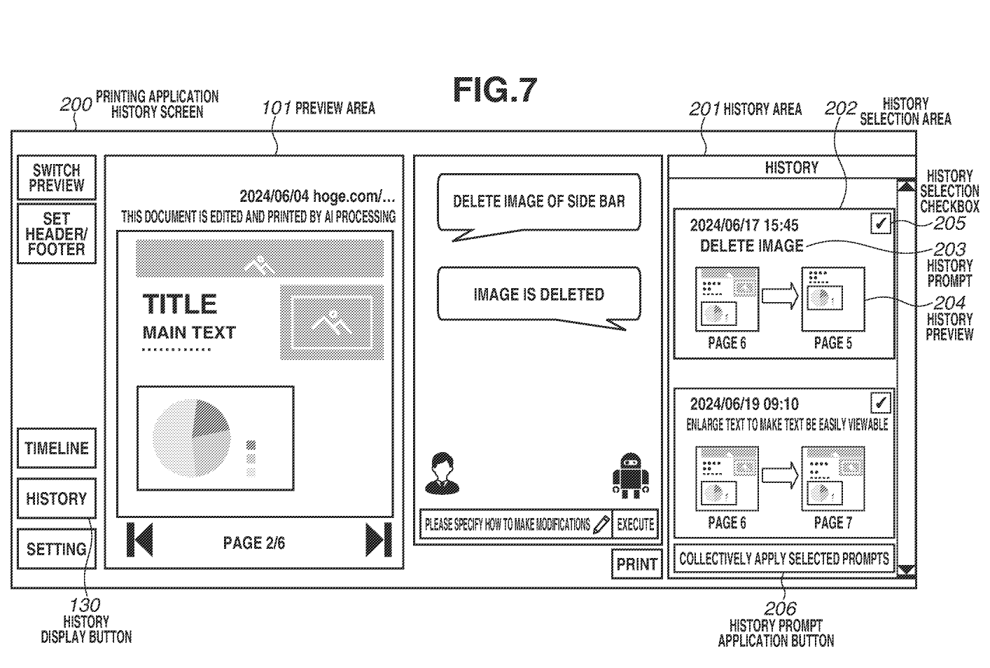

The printing application screen 100 includes other objects such as a printing execution button 120, a history display button 130, a setting screen display button 131, and a timeline display button 132. When the printing execution button 120 is pressed, the printing application 1100 starts transmission processing of a print job to be printed by the printer 2000. When the printing execution button 120 is selected, a print job including image data of an image displayed in the preview area 101 at the time of selecting the printing execution button 120 is transmitted to the printer 2000. A user interface (UI) for displaying a conversion history of the past print data is displayed when the history display button 130 is selected. A screen displaying a conversion history of the past print data is described in FIG. 7. When a press of the setting screen display button 131 is detected, a setting screen (not illustrated) of the printing application 1100 is displayed. This setting screen may include a printer selection object for selecting a printer for printing a printing target, a copy number object for specifying the number of print copies, and a color setting object for specifying a printing color. The setting screen further includes setting values related to conversion and generation of print data executed by the generative AI server 3000. For example, the above-described setting values include a setting value for disabling/enabling the historical management of the conversion (generation) result, a setting value for disabling/enabling the processing for embedding a prompt used for conversion in the print data, and a setting value for disabling/enabling the processing for causing the printing application 1100 to automatically execute conversion processing by using the embedded prompt.

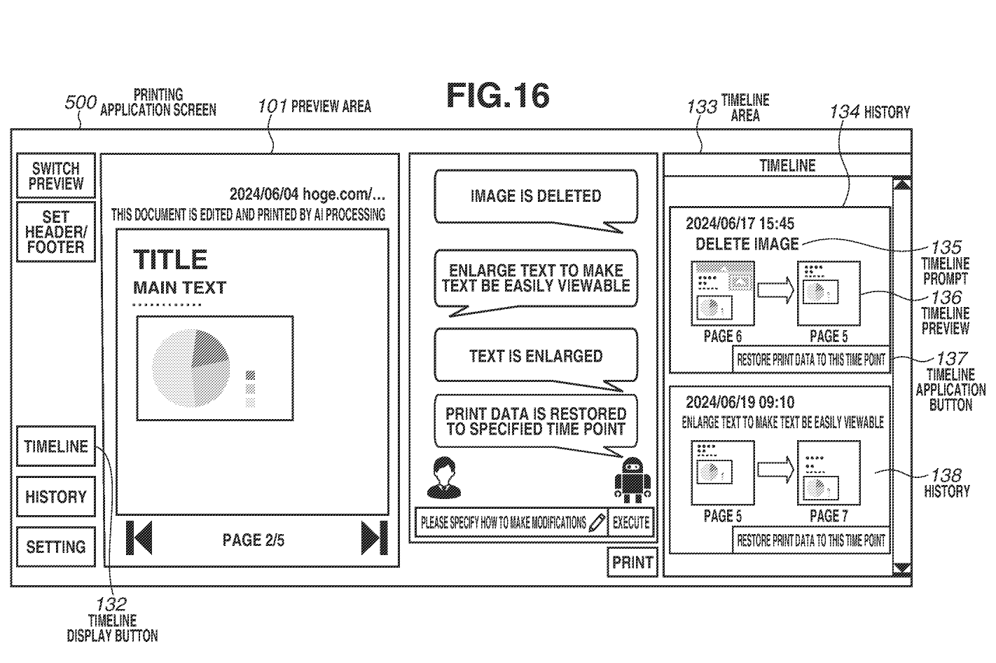

When a press of the timeline display button 132 is detected, a conversion history of the current print data is displayed on the UI through a timeline method. A timeline screen is described in FIG. 16.

### Example of Printing Application History Screen

In order to allow the user to select and apply the prompt input in the past to the current printing processing, the printing application 1100 displays history data describing past data. As an example of a screen for displaying history data describing past data, which the printing application 1100 according to the present embodiment displays on the computer 1000 or the printer 2000, a printing application history screen 200 is described with reference to FIG. 7.

Description of the object similar to the object included in the printing application screen 100 is omitted. When a press of the history display button 130 is detected, the printing application 1100 acquires history data from the generative AI service 3100 and displays a history area 201. In FIG. 7, although the history area 201 is displayed on the right side of the chat area 110, the history area 201 may be displayed in another area or may be displayed as a separate window.

The history area 201 includes a history selection area 202 and a history prompt application button 206. The history selection area 202 is arranged for each history data, so that the history area 201 includes the plurality of history selection areas 202. Each of the history selection areas 202 includes a history prompt 203, a history preview 204, and a history selection checkbox 205. Each of the history selection areas 202 may further include conversion date/time of the history data and a printing target name such as a file name or a URL of the printing target. The history prompt 203 is a prompt used for the conversion of the print data (i.e., a prompt which the user has previously input to the chat input area 111). The history preview 204 displays a preview before conversion and a preview after conversion based on the history prompt 203 side-by-side. The history preview 204 may also include the number of pages changed before and after conversion. Further, a page that is remarkably changed before and after conversion based on the history prompt 203 may be displayed in the history preview 204. Because the history prompt 203 and the history preview 204 are displayed together in the history selection area 202, the user can check the prompt used previously and a result of image generation based on the prompt, so that the user can easily select a desired prompt. The history selection checkbox 205 is a selection box for selecting a history prompt to be applied to the current print data. In FIG. 7, two history prompts 203, "Delete the image" and "Enlarge text to make the text be easily viewable", are selected. When a press of the history prompt application button 206 is detected, the plurality of history prompts 203 selected currently and the current print data are transmitted to the generative AI service 3100. When the user selects the history prompt application button 206, the generative AI service 3100 sequentially applies the prompts to the print data. The printing application 1100 receives a conversion result in which all of conversions are applied, and reflects the conversion result in the preview area 101 and the chat area 110.

In other words, when the history prompt application button 206 is selected, the printing application 1100 transmits the prompt included in the selected history and image data of the image displayed in the preview area 101 to the generative AI server 3000. Therefore, the generative AI server 3000 generates (converts) the image data based on the received prompt and the received image data. The printing application 1100 receives the image data generated by the generative AI server 3000, and displays an image of the received image data in the preview area 101.

Then, when the printing execution button 120 is selected by the user, the printing application 1100 transmits the image data received from the generative AI server 3000 to the printer 2000. At this time, a print job including the above-described image data and a print setting set by the user through the printing application 1100 is transmitted. Then, the printer 2000 receives the print job, executes the received print job, and prints an image on a sheet.

In other words, the printing application 1100 can display a history which includes an image generated based on the prompt input by the user and an image of the input first image data.

Further, the printing application 1100 can display an image generated based on a prompt included in a history selected from displayed histories and an image of second image data different from the first image data input previously.

The printing application 1100 can also transmit a prompt input by the user and the first image data input by the user to the generative AI server 3000. Then, the printing application 1100 can receive image data of an image generated based on the transmitted prompt and the transmitted first image data. By executing the above-described processing, the printing application 1100 can store a combination of the prompt transmitted by the above-described processing and the image data generated based on the prompt as the history data. The user can check this history data in the history area 201. In other words, a history including an input prompt and an image of the image data received from the generative AI server 3000 is displayed in the history area 201.

Further, the printing application 1100 can transmit a prompt included in a history selected from displayed histories and the input second image data to the generative AI server 3000. Then, the printing application 1100 receives image data of an image generated based on the transmitted prompt, i.e., the prompt included in the selected history, and the image of the second image data from the generative AI server 3000. Then, the printing application 1100 displays an image of the received image data in the preview area 101. Further, as illustrated in the screen in FIG. 7, a list of histories is selected in a state where the second image data is displayed.

Further, the printing application 1100 can accept print settings such as a color mode setting, a two-sided print setting, and a sheet size setting. Then, when the user selects the printing execution button 120, the printing application 1100 transmits the print setting specified by the user and image data of the image displayed in the preview area 101 to the printer 2000.

Further, after the history is displayed, the printing application 1100 receives image data from the generative AI server 3000 without accepting an input of a prompt displayed in the history from the user. The received image data is image data of an image generated based on a prompt included in the selected history and an image of the second image data. Then, the printing application 1100 displays the image of the image data in the preview area 101.

Further, an image generated based on the prompt included in the selected history and an image of the input second image data and information describing that generative AI is used to generate the image are displayed in the preview area 101.

In addition, the above-described processing executed by the printing application 1100 is implemented by the CPU 111 of the computer 1000 executing the printing application 1100.

### Structure of History Data

A structure of history data saved by the data management unit 3103 of the generative AI service 3100 is described with reference to FIG. 8. A table of a history data database (DB) 300 illustrated in FIG. 8 include a prompt 301, data before conversion 302, data after conversion 303, a job identifier 304, and date/time 305 as items of history data. One row of the history data DB 300 describes a piece of history data. The prompt 301 is a prompt the generative AI service 3100 has received as a conversion request. The data before conversion 302 is print data before conversion executed based on the prompt. The data after conversion 303 is print data after conversion executed based on the prompt. The data before and after conversion may be saved in the external storage as files, instead of being directly saved in the history data DB 300. Then, information for specifying the files saved in the external storage may be saved in the history data DB 300. For example, a file name of a printing target or a URL of the printing target is saved as the job identifier 304. The date/time 305 is a date and time when conversion is executed based on the prompt. In addition, the history data DB 300 is stored in the HDD 314 of the computer 1000.

### Example of Printing Application Timeline Screen

The printing application 1100 displays a timeline of conversion results, so that the user is allowed to select a prompt input in the past, associated with the current print data, in order to restore the current print data to the print data at that time point.

The processing is described by taking a specific example. For example, the user inputs image data to the printing application 1100, inputs a first prompt such as "Delete the image", and issues an execution instruction. The printing application 1100 receives the instruction and transmits the input first prompt and the input image data to the generative AI service 3100. Then, the printing application 1100 receives image data of an image generated based on the first prompt and the image of the transmitted image data from the generative AI service 3100. This image data is image data of an image the generative AI service 3100 has generated based on the first prompt and the image of the transmitted image data.

Then, the printing application 1100 displays an image (first image) of the image data received from the generative AI service 3100 in the preview area 101.

Next, in order to further edit the image (first image) of the image data received from the generative AI service 3100, the user inputs an additional prompt (second prompt). For example, the user inputs a prompt such as "Enlarge text to make the text be easily viewable", and issues an execution instruction.

With this operation, the printing application 1100 transmits image data of the first image and the second prompt to the generative AI service 3100. The generative AI service 3100 similarly generates an image (second image) based on the first image and the second prompt, and transmits image data of the generated image to the printing application 1100.

The printing application 1100 displays the second image in the preview area 101 based on the image data of the second image received from the generative AI service 3100.

As a result of checking the second image in the preview area 101, the user finds out that the first image is more appropriate. Therefore, the user executes processing for restoring the image to be printed to the first image. The present disclosure can reduce time and effort necessary to execute the above processing.

A timeline area 133 is displayed on the printing application screen 100 when the user selects a timeline display button 132.

One or a plurality of histories is displayed in chronological order in the timeline area 133. As in the history 134, a timeline preview 136 including images before and after conversion and a prompt (timeline prompt 135) used for the conversion processing are displayed in each of the histories. A timeline application button 137 is also displayed in each of the histories, and an image associated with the selected timeline item (history) is displayed in the preview area 101 when the timeline application button 137 is selected. In other words, the user can restore the image displayed in the preview area 101 to the image converted or generated previously. Further, a date and time when a history is created is included and displayed in each of the histories displayed in the timeline area 133.

Each of the histories is created when image data of a generated image is received from the generative AI service 3100 after the user inputs a prompt and issues an execution instruction of image generation.

The created history is stored in the HDD 114 of the computer 1000.

In a case where the second image is generated after the first image is generated according to instructions, the second image is displayed in the preview area 101. Thereafter, when the timeline application button 137 is selected, the first image is displayed in the preview area 101 again as illustrated in a printing application screen 500 in FIG. 16.

As described above, the printing application 1100 according to the present embodiment displays the first image generated based on the first prompt input by the user and an image of the input image data in the first display area. Further, in a state where the second image generated based on the second prompt input by the user and the first image is displayed in the first display area, the printing application 1100 displays histories associated with the first image in the second display area. Then, the printing application 1100 accepts a printing instruction, and transmits print data including image data of the image displayed in the first display area to the printing apparatus (printer 2000).

Further, in a case where the history associated with the first image is selected from the displayed histories when the second image is displayed in the first display area, the first image is displayed in the first display area. The first prompt is a prompt which is input earlier than the second prompt.

Then, an image displayed in the preview area 101 (first display area) when the printing execution button 120 is selected by the user is an image to be transmitted as print data. In other words, the printing application 1100 has a print data transmission function, through which print data including image data of the first image and the print setting is transmitted to the printer 2000, when the printing execution button 120 is selected in a state where the first image is displayed in the preview area 101. Here, the print setting accepted by the printing application 1100 via a print setting screen (not illustrated) is transmitted. Further, images included in the history 134 in FIG. 16 are the image input by the user and the first image generated based on the input image and the first prompt input by the user. An image on the left side of an arrow is the input image, and an image on the right side is the generated first image. Furthermore, images included in the history 138 in FIG. 16 are the above-described first image and the second image generated based on the first image and the second prompt input by the user. An image on the left side of an arrow is the first image, and an image on the right side is the generated second image. It is obvious from the date and time that the history 138 is created and displayed after the history 134.

Further, the history displayed in the timeline area 133 may be reset when the printing application 1100 accepts a printing instruction. In other words, the user can restore the image derived from one image to the original state before the user issues a printing instruction.

In FIG. 16, although the timeline area 133 is displayed on the right side of the chat area 110, the timeline area 133 may be displayed in another area or may be displayed as a separate window. The timeline preview 136 may also include the number of pages changed before and after conversion. Further, a page that is remarkably changed before and after conversion based on the history prompt may be displayed in the timeline preview 136. When a press of the timeline application button 137 is detected, the print data is restored to a state at a selected time point, and the print data displayed in the preview area 101 is updated with the print data at the selected time point. At this time, a character string describing a result of restoration may be displayed in the chat area 110.

In FIG. 16, the user has input two prompts, "Delete the image" and "Enlarge text to make the text be easily viewable", and converted print data is displayed. In a case where the timeline application button 137 included in the timeline item (i.e., history 134) displaying the prompt "Delete the image" is pressed, the current print data is changed to the converted data illustrated in the timeline item including the pressed timeline application button 137, and this change is also reflected on the print data displayed in the preview area 101. Although an example of the processing for restoring the current print data to the print data after conversion is described in FIG. 16, the current print data may be restored to the print data before conversion.

### Structure of Timeline Data

A structure of timeline data saved by the data management unit 1103 of the printing application 1100 is described with reference to FIG. 17. A table of a timeline data DB 400 illustrated in FIG. 17 includes a prompt 401, data before conversion 402, data after conversion 403, and date/time 305 as items of timeline data. One row of the timeline data DB 400 describes a piece of timeline data.

The prompt 401 is a prompt the printing application 1100 has transmitted to the generative AI service 3100 as a conversion request. The data before conversion 402 is print data before conversion executed based on the prompt. The data after conversion 403 is print data which the printing application 1100 has received as a result of conversion executed by the generative AI service 3100 based on the prompt. The data before and after conversion may be saved in the external storage as files, instead of being directly saved in the timeline data DB 400. Then, information for specifying the files saved in the external storage may be saved in the timeline data DB 400. The date/time 405 is a date and time when conversion is executed based on the prompt.

### Example of Printing Application Screen for Using File Metadata

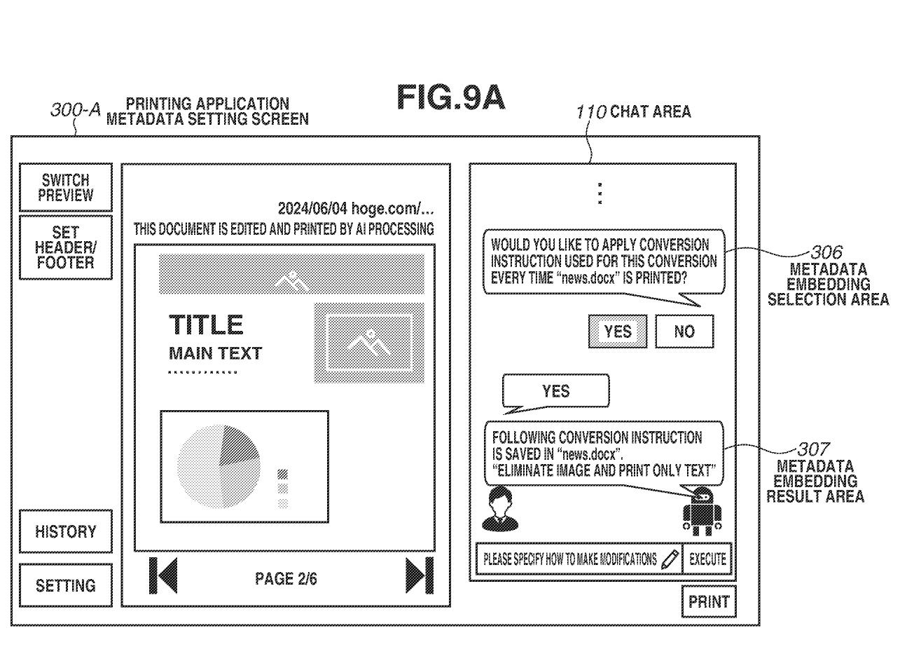

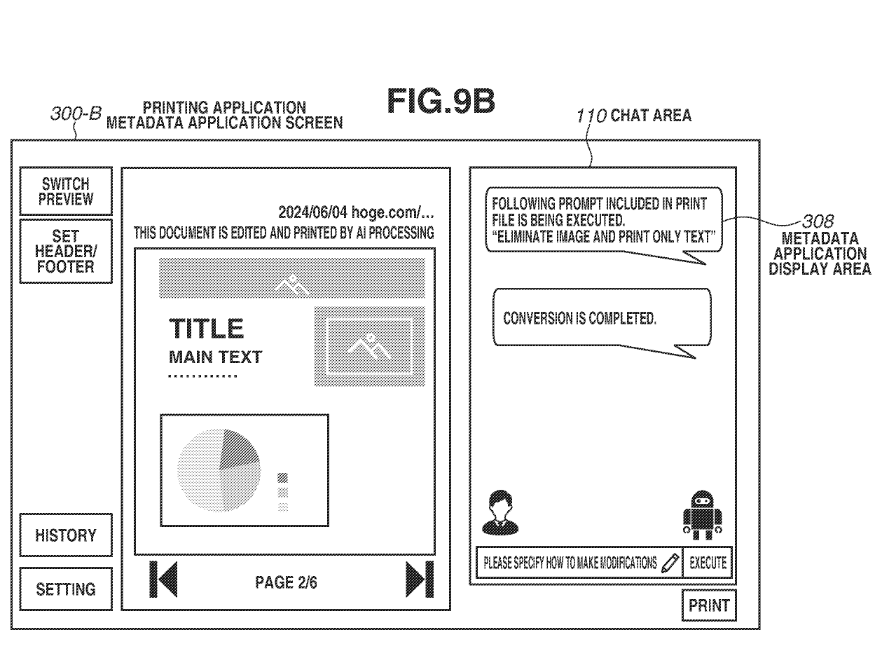

In order to reduce time and effort necessary to input a same prompt every time a file is printed, the printing application 1100 uses file metadata. A printing application metadata setting screen 300-A and a printing application metadata application screen 300-B for applying file metadata as a prompt, according to the present embodiment, are described with reference to FIG. 9. Description of an object similar to the object described in the printing application screen 100 is omitted.

First, the printing application metadata setting screen 300-A is described. After the printing application 1100 detects a press of the printing execution button 120 to start executing printing, the printing application 1100 displays a metadata embedding selection area 306 in the chat area 110 to allow the user to select whether to embed a prompt used for the conversion executed this time in a printing target file. In order to allow the user to easily input a response, the metadata embedding selection area 306 may include an object for selecting whether to embed the prompt. Alternatively, the response may be input to the chat area 110 in natural language. Further, as a response, the user may input an instruction for embedding a part of the prompt input already or a new prompt which is not input before. When the printing application 1100 detects an instruction for embedding metadata, the printing application 1100 embeds a prompt used for conversion in the metadata of the printing file. Thereafter, the printing application 1100 displays a metadata embedding result area 307 in the chat area 110.

An example of the processing for reading and using the metadata embedded through the printing application metadata setting screen 300-A is described with reference to the printing application metadata application screen 300-B for applying file metadata as a prompt. The printing application 1100 reads print data and checks whether a prompt is included in the metadata. In a case where the prompt is included in the metadata, the printing application 1100 displays a metadata application display area 308. The content of the embedded prompt and text describing conversion is being executed based on the prompt are displayed in the metadata application display area 308. When the conversion is completed, the printing application 1100 reflects the conversion result in the preview area 101 and the chat area 110.

### Flow of Processing

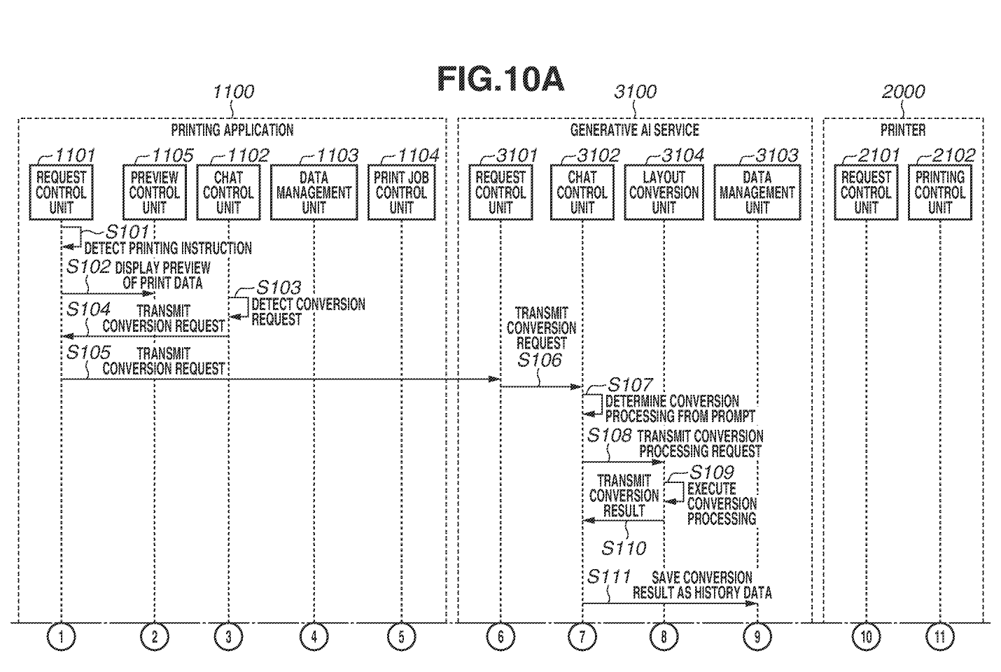

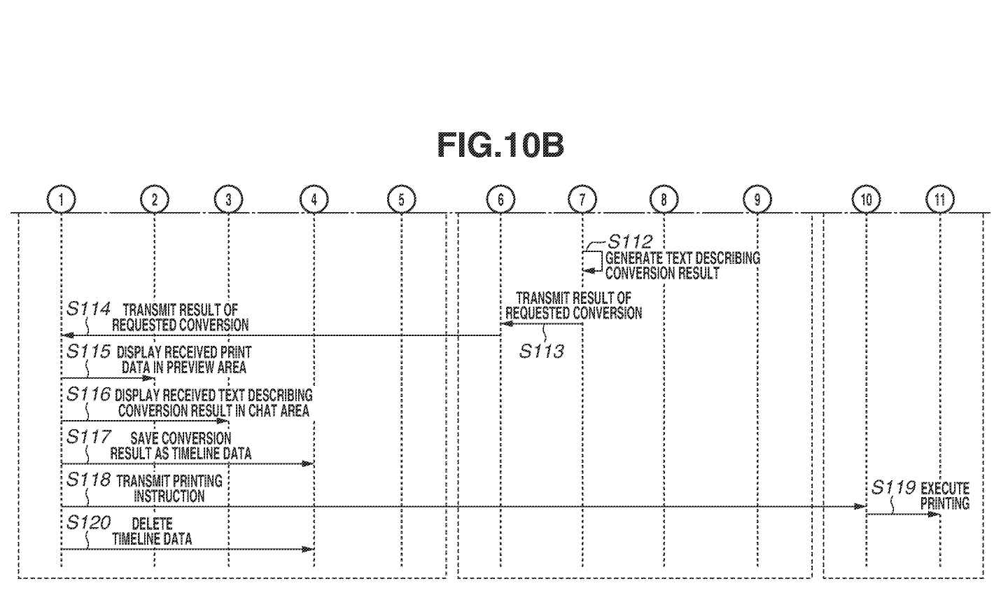

Layout conversion processing sequentially executed by the generative AI service 3100 according to the present embodiment is described with reference to the sequence diagram in FIGS. 10A and 10B. The processing sequentially executed by the elements constituting the computer 1000, the printer 2000, and the generative AI service 3100 is described. The below-described numbers following after a letter "S" are step numbers which indicate sequence.

In step S101, the request control unit 1101 of the printing application 1100 detects a printing request from the computer 1000. The printing request includes print data as a printing target.

In step S102, the request control unit 1101 causes a preview control unit 1105 to display a preview of the received print data.

The chat control unit 1102 of the printing application 1100 detects a conversion request input by the user in step S103, and transmits the conversion request to the request control unit 1101 in step S104. In step S105, the request control unit 1101 transmits the received conversion request to the request control unit 3101 of the generative AI service 3100. The conversion request includes a prompt input to the chat input area 111 by the user and the print data. In step S106, the request control unit 3101 transmits the received conversion request to the chat control unit 3102. In step S107, the chat control unit 3102 interprets the received prompt described in natural language and the received print data, and determines layout conversion processing with respect to the print data. In step S108, the chat control unit 3102 transmits a request for layout conversion processing to the layout conversion unit 3104. In step S109, the layout conversion unit 3104 executes the layout conversion processing included in the conversion request on the print data included in the conversion request. In step S110, the layout conversion unit 3104 returns a conversion result to the chat control unit 3102. In step S111, the chat control unit 3102 saves the conversion result in the data management unit 3103 as history data. An example of the saved history data is illustrated in FIG. 8. In step S112, according to the conversion result received in step S110, the chat control unit 3102 generates text describing the conversion result indicating success or failure of the conversion. In step S113, the chat control unit 3102 returns a result of requested conversion to the request control unit 3101. In step S114, the request control unit 3101 returns the result of requested conversion to the request control unit 1101 of the printing application 1100. The result of requested conversion includes the print data after conversion returned from the layout conversion unit 3104 in step S110 and the text describing the conversion result generated in step S112.

In step S115, the request control unit 1101 causes the preview control unit 1105 to display a preview of the print data included in the received result of requested conversion. In step S116, the request control unit 1101 causes the chat control unit 1102 to display the text describing the conversion result included in the received result of requested conversion in the chat area 110. In step S117, the request control unit 1101 saves the received conversion result, execution date and time of conversion, the prompt used for the conversion, and print data before conversion in the data management unit 1103 of the printing application 1100 as timeline data. After that, by repeatedly executing the processing in steps S103 to S117 for the optional number of times, print data in a layout desired by the user can be generated. In the present embodiment, print data is transmitted as a conversion request every time. However, in order to reduce the communication volume, the print data transmitted in step S105 may be saved in the data management unit 3103 of the generative AI service 3100. Then, from the second time onward, the conversion request without including the print data may be transmitted, and the latest print data after conversion, saved in the data management unit 3103, may be specified as a target of the conversion processing in step S109. When the print data expected by the user is generated, the request control unit 1101 detects a printing instruction. Therefore, in step S118, the request control unit 1101 transmits the printing instruction to the request control unit 2101 of the printer 2000. In step S119, the request control unit 2101 causes the printing control unit 2102 to execute printing. In step S120, the request control unit 1101 of the printing application 1100 deletes the unnecessary timeline data from the data management unit 1103.

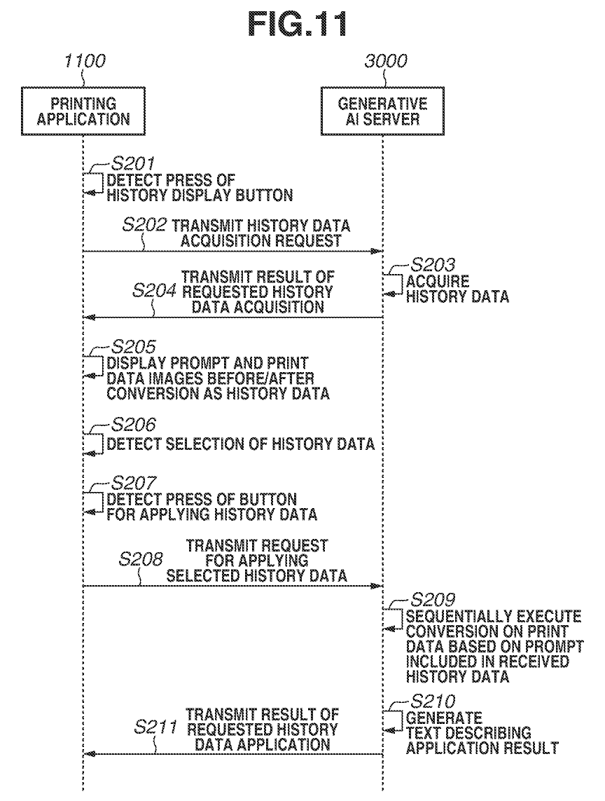

The sequence processing for displaying a history and applying a history prompt to the current print data in the printing application 1100 according to the present embodiment is described with reference to the sequence diagram in FIG. 11. The processing sequentially executed by the printing application 1100 and the generative AI service 3100 is described.

The below-described numbers following after a letter "S" are step numbers which indicate sequence.

In step S201, the printing application 1100 detects a press of the history display button 130. In step S202, the printing application 1100 transmits a history data acquisition request to the generative AI service 3100. In step S203, the generative AI service 3100 acquires history data from the data management unit 3103. The history data acquired in step S203 is history data of the user who transmits the acquisition request. In step S204, the generative AI service 3100 returns a result of requested history data acquisition to the printing application 1100. The result of requested history data acquisition includes a plurality of history prompts and data before/after conversion associated with the plurality of history prompts, date/time information, and job identifiers. In step S205, the printing application 1100 displays the history prompts and images of print data before and after conversion included in the result of requested history data acquisition received in step S204 as sets, each of which includes a history prompt and images of print data before and after conversion associated with the history prompt. In a case where a plurality of pieces of history data is included, the printing application 1100 makes sets and displayed as a plurality of histories. The history may include the number of pages changed before and after of conversion. Further, a page that is remarkably changed before and after conversion based on the history prompt may be displayed as the images of the print data before and after conversion.

In this way, the user can select a prompt to be applied to the current print data while checking the prompt and the images before and after conversion based on the history prompt.

In step S206, the printing application 1100 detects selection of the history data. This selection may be performed with respect to a plurality of pieces of history data. In a case where a plurality of pieces of history data is selected, the printing application 1100 stores the order of selection. The UI of the printing application 1100 may display selection numbers indicating the order of selection. In step S207, the printing application 1100 detects a press of a button for applying the history data. In step S208, the printing application 1100 transmits a request for applying the selected history data to the generative AI service 3100. A request for applying history data includes a prompt included in selected history data, the selection order, and image data currently displayed in the preview area 101. In step S209, the generative AI service 3100 sequentially interprets the prompt included in the received history data according to the selection order, and executes layout conversion processing (image generation) on the print data. In step S210, the generative AI service 3100 generates text describing a result of applying the history prompt. In step S211, the generative AI service 3100 transmits a result of requested history data application to the printing application 1100. This result of application includes the print data converted in step S209 and the text describing the conversion result generated in step S210.

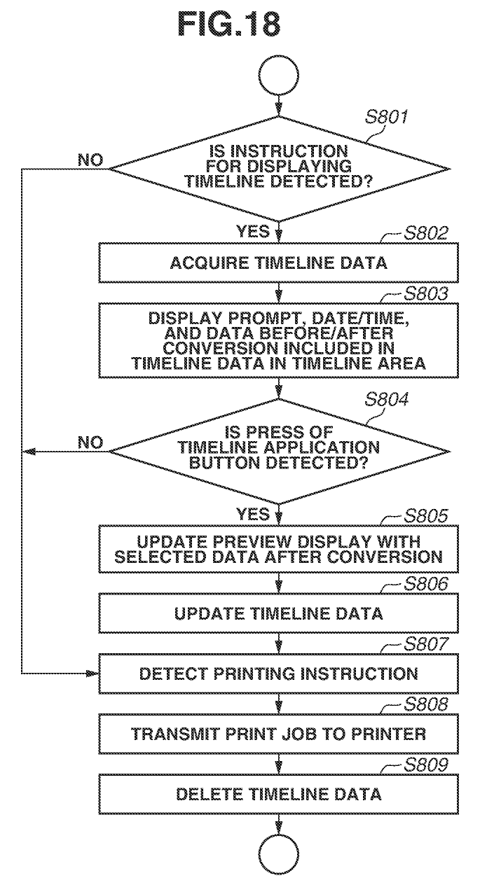

The processing for displaying timeline data and the processing for restoring the print data to a selected time point, executed by the printing application 1100 according to the present embodiment, are described with reference to FIG. 18. The flowchart in FIG. 18 is described based on the assumption that the processing is to be executed after the conversion processing in steps S103 to S117 in FIGS. 10A and 10B is executed by the generative AI service 3100 for a plurality of times. In other words, the processing is executed in a state where a plurality of pieces of timeline data (history data) is stored in the timeline data DB 400.

In step S801, the timeline display button 132 is pressed, so that the printing application 1100 checks whether an instruction for displaying a timeline is detected. In a case where an instruction for displaying a timeline is detected (YES in step S801), the processing proceeds to step S802. In step S802, the printing application 1100 acquires timeline data saved in the timeline data DB 400 included in the data management unit 1103 of the printing application 1100. In step S803, the printing application 1100 displays a prompt, a date and time, and print data before and after conversion included in the timeline data in the timeline area 133 as a history 134, by the number corresponding to the pieces of acquired timeline data. At this time, histories 134 are sorted and displayed in the chronological order according to the date and time included in the acquired timeline data. In step S804, the printing application 1100 checks whether a press of the timeline application button 137 included in one of the histories 134 displayed in the timeline area 133 is detected. In a case where a press of the timeline application button 137 is detected (YES in step S804), the processing proceeds to step S805. In step S805, the printing application 1100 updates the preview area 101 with print data after conversion which is included in the history 134 including the pressed timeline application button 137. At this time, a character string describing a result of restoration may be displayed in the chat area 110. Thereafter, in step S806, the printing application 1100 updates the timeline data DB 400. Specifically, as the timeline data, time when the timeline application button 137 is pressed is saved as the date/time 405, print data before the timeline application button 137 is pressed is saved as the data before conversion 402, print data after the timeline application button 137 is pressed is saved as the data after conversion 403, and a character string describing restoration of data from a timeline is saved as the prompt 401. Through the above-described processing, the printing application 1100 can easily restore the print data to print data at an optional time point, converted based on the prompt.

Thereafter, the printing application 1100 detects a printing instruction in step S807 and transmits a print job to the printer 2000 in step S808. The print data transmitted in step S808 includes image data of an image displayed in the preview area 101 when the printing execution button 120 is selected. After printing is executed, in step S809, the printing application 1100 deletes all of the timeline data saved in the timeline data DB 400.

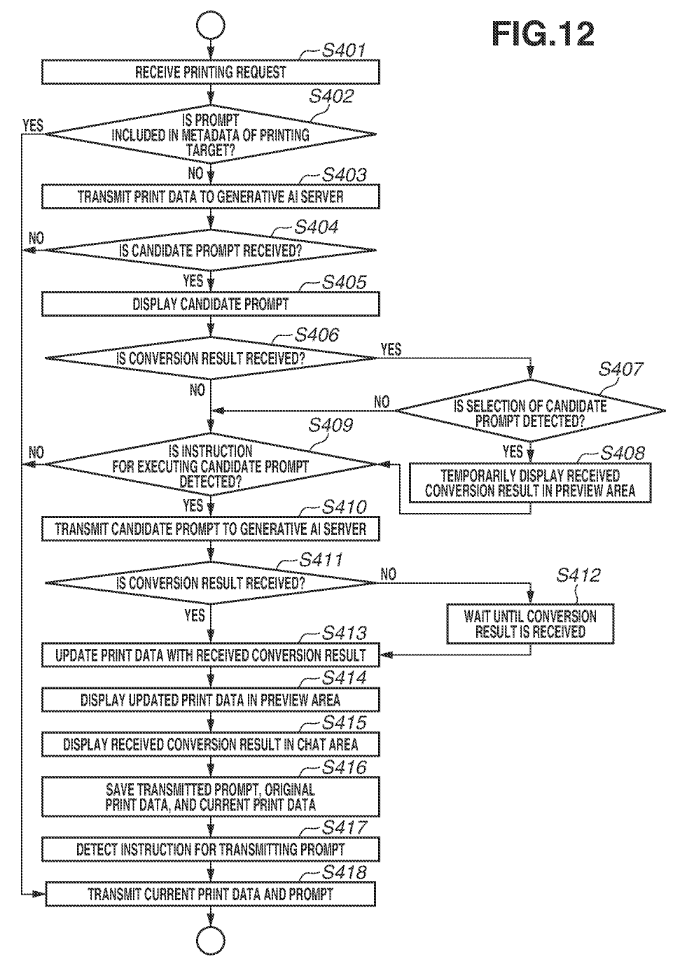

The processing executed by the printing application 1100 in a case where a prompt is embedded in a printing target file as metadata is described with reference to FIG. 12. The processing includes processing for automatically applying a prompt and processing for providing a prompt appropriate for print data to the user by using history data.

In step S401, the printing application 1100 receives a printing request from the computer 1000. In step S402, the printing application 1100 checks whether print data included in the received printing request is a file, and also checks whether a prompt is included as the metadata of the file. The printing application 1100 checks whether the metadata describes a prompt, based on a name of the metadata or based on whether an identification character string specified by the printing application 1100 is included in the metadata itself. In a case where a prompt is included in the metadata (YES in step S402), the processing proceeds to step S418. In step S418, the printing application 1100 transmits the current print data and the prompt to the generative AI service 3100 in order to promptly execute the prompt. In a case where a prompt is not included in the metadata (NO in step S402), the processing proceeds to step S403. In step S403, the printing application 1100 transmits only the print data to the generative AI service 3100. In step S404, the printing application 1100 checks whether a prompt as a conversion candidate is received from the generative AI service 3100. In a case where a prompt is not received (NO in step S404), no candidate is present. Therefore, the printing application 1100 advances the processing to S418. In a case where a prompt is received (YES in step S404), a candidate is present. Therefore, in step S405, the printing application 1100 displays the candidate prompt received in step S404 in the chat area 110 as an object which can be selected by the user. In step S406, the printing application 1100 checks whether data converted based on the candidate prompt is received. In a case where the converted data is not received (NO in step S406), the printing application 1100 does nothing and advances the processing to step S409. In a case where the converted data is received (YES in step S406), the processing proceeds to step S407. In step S407, the printing application 1100 checks whether selection of the object displayed in step S405 is detected. For example, the printing application 1100 checks whether an action such as putting a mouse cursor over the object displaying the candidate prompt (i.e., mouseover) or pressing and holding the object displaying the candidate prompt is detected. In a case where the action is detected (YES in step S407), the processing proceeds to step S408. In step S408, the converted data received in step S406 is temporarily displayed in the preview area 101 while the action is being detected. In a case where a mouse cursor is removed from the object where the candidate prompt is displayed, so that the action is no longer detected, for example, print data displayed in the preview area 101 is restored to the original print data. In this way, the user can easily check the conversion result before the user confirms the conversion by selecting the candidate prompt. In a case where selection of the candidate prompt is not detected in step S407 (NO in step S407), the printing application 1100 does nothing and advances the processing to step S409 even if the mouseover is detected. In step S409, the printing application 1100 checks whether an execution instruction is detected after the object displaying the candidate prompt is selected. In a case where the execution instruction is not detected (NO in step S409), the candidate is not selected. Therefore, the printing application 1100 advances the processing to S418. In a case where the execution instruction is detected (YES in step S409), the processing proceeds to step S410. In step S410, the printing application 1100 transmits the selected candidate prompt to the generative AI service 3100. In step S411, the printing application 1100 checks whether a result of conversion based on the candidate prompt transmitted in step S410 is received. In a case where the conversion result is not received (NO in step S411), the printing application 1100 advances the processing in step S412, and waits until the conversion result is received. In a case where the conversion result is received (YES in step S411), the processing proceeds to step S413. In step S413, the printing application 1100 updates the print data by using the received conversion result.

In step S414, the printing application 1100 updates the preview area 101 with the print data updated in step S413. In step S415, the printing application 1100 displays text describing the conversion result received in step S412 in the chat area 110. In step S416, the printing application 1100 saves the transmitted prompt, the original print data, and the current print data after conversion in the data management unit 1103 in association with each other. Through the above-described processing, in a case where the prompt is embedded as the metadata in the printing target file, it is possible for the printing application 1100 to implement the processing for automatically applying the prompt and the processing for providing the prompt appropriate for the print data to the user by using the history data. The printing application 1100 can continuously execute the conversion processing by accepting a prompt input by the user. In step S417, the printing application 1100 detects an instruction for transmitting the prompt. In step S418, the printing application 1100 transmits the current print data and the prompt to the generative AI service 3100. Then the processing in this flowchart ends.

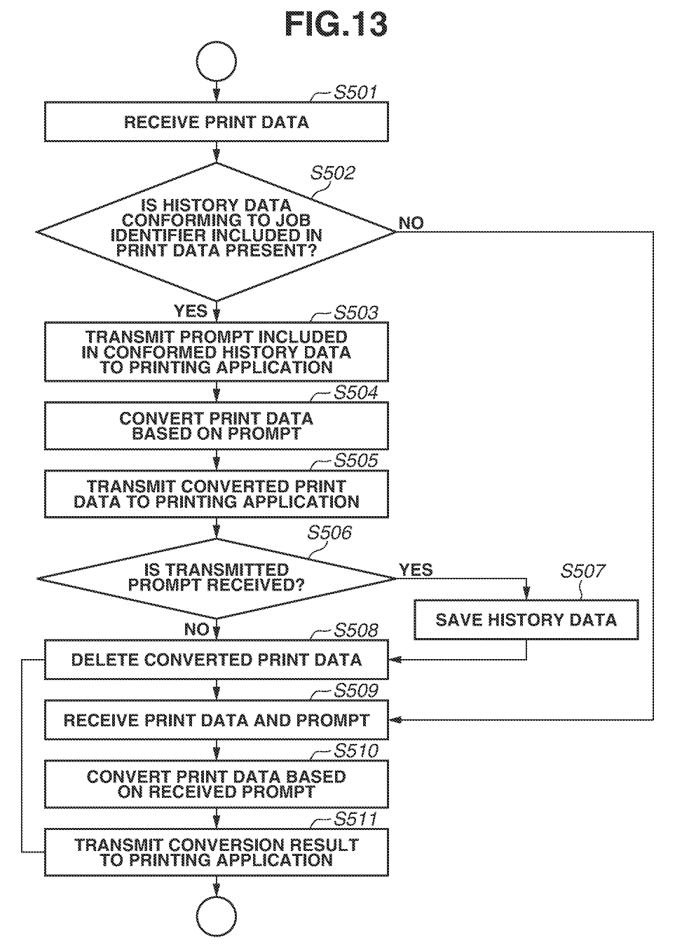

The processing for providing a prompt appropriate for the received print data to the user by using history data, executed by the generative AI service 3100, is described with reference to FIG. 13. In step S501, the generative AI service 3100 receives print data from the printing application 1100. In step S502, the generative AI service 3100 checks whether history data having the job identifier 304 conforming or similar to the job identifier included in the print data received in step S501 is present in the pieces of history data saved in the data management unit 3103. In a case where the history data is not present (NO in step S502), the generative AI service 310 does not generate a candidate prompt. Therefore, the generative AI service 3100 advances the processing to step S509 to receive the prompt from the printing application 1100. In a case where the history data is present (YES in step S502), the processing proceeds to step S503. In step S503, the generative AI service 310 transmits the prompt 301 of the history data whose job identifier 304 conforms to or is similar to the job identifier included in the print data to the printing application 1100 as the candidate prompt. At this time, a plurality of candidate prompts can be transmitted if more than one candidate prompt is present. In step S504, the generative AI service 3100 previously starts executing layout conversion based on the candidate prompt before the instruction for executing the candidate prompt is transmitted from the printing application 1100. In a case where a plurality of candidate prompts is present, layout conversion is started based on the plurality of candidate prompts. In step S505, when conversion is completed, the generative AI service 3100 transmits the converted print data to the printing application 1100. As described above, by previously starting the conversion processing with respect to the candidate prompt, it is possible to reduce the waiting time in a case where the user who uses the printing application 1100 applies the candidate prompt. In step S506, the generative AI service 3100 checks whether the candidate prompt transmitted in step S503 is received. In a case where the candidate prompt is received (YES in step S506), the processing proceeds to step S507. In step S507, the generative AI service 3100 saves the history data in the data management unit 3103. Then, in step S508, the generative AI service 3100 deletes the print data converted based on the candidate prompt because this print data is not necessary. In a case where the candidate prompt is not received (NO in step S506), the candidate prompt is not selected. Therefore, in step S508, the generative AI service 3100 similarly deletes the converted print data. In step S509, the generative AI service 3100 receives print data and a prompt from the printing application 1100. In step S510, the generative AI service 3100 interprets the prompt received in step S509, and executes conversion processing on the print data. In step S511, the generative AI service 3100 transmits the conversion result to the printing application 1100. Then, the processing in this flowchart ends.

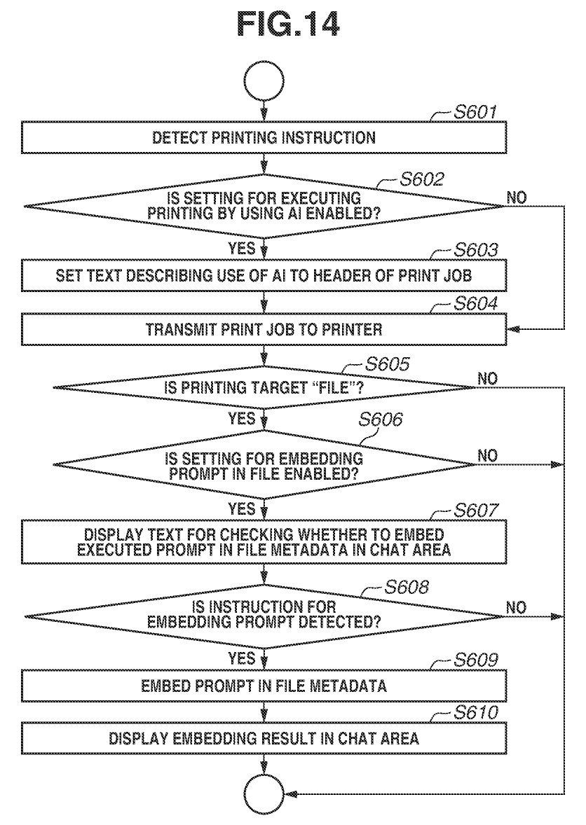

Processing for executing printing after applying a print footer and processing for embedding a prompt in a file metadata, executed by the printing application 1100, are described with reference to FIG. 14. In step S601, the printing application 1100 detects a printing instruction issued by a press of a print button. In step S602, the printing application 1100 checks whether a setting for executing printing by using AI is enabled as a setting of the printing application 1100. In a case where the setting is enabled (YES in step S602), the processing proceeds to step S603. In step S603, the printing application 1100 adds a character string describing use of AI for editing to the header of the print job. For example, a character string "This document is edited and printed by AI processing" is printed. In this way, the user who looks at the printed matter can be aware that the printed matter is not directly printed from a file or a web site. A character string describing that AI is used to edit the printed matter may be previewed and printed in a print footer area or other blank space, or may be previewed and printed so as to be included in the main text of the printed matter instead of in the print header area. In step S604, the printing application 1100 creates a print job from the current print data, and transmits the print job to the printer 2000. In step S605, the printing application 1100 checks whether a printing target is "file". In a case where a printing target is not a file (NO in step S605), the processing ends. In a case where a printing target is a file (YES in step S605), the processing proceeds to step S606. In step S606, the printing application 1100 checks whether a setting for embedding a prompt in a file is enabled as a setting of the printing application 1100. In a case where the setting is not enabled (NO in step S606), the processing ends. In a case where the setting is enabled (YES in step S606), the processing proceeds to step S607. In step S607, the printing application 1100 displays a character string for checking whether to embed the prompt used for conversion as the metadata of the file in the chat area 110. For example, button controls including character strings "YES" and "NO" which can be pressed by the user are displayed together with a character string "Would you like to embed a prompt "Delete the image" in "news.docs" to automatically apply this prompt from the next time?". In step S610, the printing application 1100 checks whether an instruction for embedding the metadata is detected. In a case where the instruction is not detected (NO in step S608), the processing ends. In a case where the instruction is detected (YES in step S608), the processing proceeds to step S609. In step S609, the printing application 1100 embeds the prompt in the file metadata. The embedded metadata includes a prompt itself and an identifier indicating that the metadata is a prompt used by the printing application 1100. For example, the identifier may be used as a key-name of the metadata, or the identifier may be included in the metadata itself. In step S610, the printing application 1100 displays an embedding result in the chat area 110, and ends the processing. Through the above-described processing, the prompt is automatically applied when the file is printed by the printing application 1100 next time.

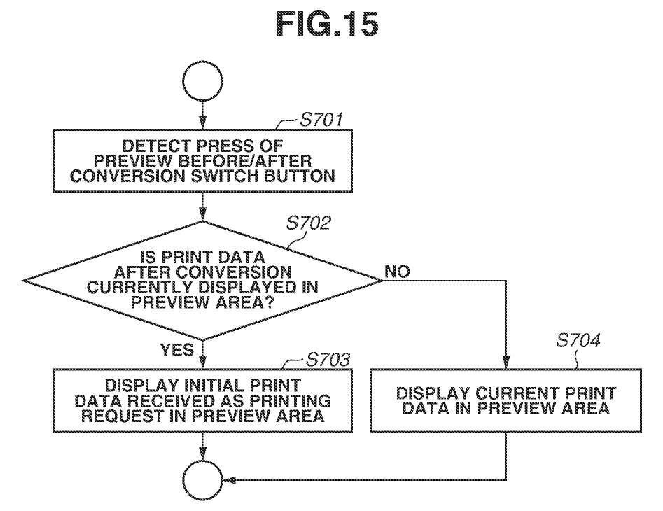

The processing for switching between the previews before and after conversion, executed by the printing application 1100, is described with reference to FIG. 15. In step S701, the printing application 1100 detects a press of the preview before/after conversion switch button 105. In step S702, the printing application 1100 checks whether a preview displayed currently is a preview of print data after conversion or a preview of initial print data before conversion.

In a case where a preview of print data after conversion is displayed (YES in step S702), the processing proceeds to step S703. In step S703, the printing application 1100 changes a display to a preview of initial print data before conversion, and ends the processing. At the same time, the printing application 1100 switches a display of a preview of the number of pages to the number of pages before conversion. In a case where a preview of print data before conversion is displayed (NO in step S702), the processing proceeds to step S704. In step S704, the printing application 1100 changes a display to a preview of the latest print data after conversion, and ends the processing. At the same time, the printing application 1100 switches a display of a preview of the number of pages to the number of pages after conversion. When the preview before/after conversion switch button 105 is pressed, a screen displaying only a preview of the latest print data and a screen displaying a preview of unedited print data and a preview of the latest print data side-by-side may be switched.

As described above, the printing system according to the present embodiment executes layout conversion through the generative AI service 3100 based on the prompt described in natural language, input to the printing application 1100 by the user, and updates a print preview. The generative AI service 3100 saves the print data before and after conversion together with the prompt as a history of layout conversion, and displays the history on the printing application 1100.

In addition, the conversion processing of image data (print data) and the layout conversion processing described above may be processing for generating new image data based on the original image data and the prompt.

In a case where editing work is repeatedly performed on an input image based on a prompt input by the user, time and effort necessary to restore the image to an image edited at a certain time point can be reduced by executing the above-described processing.

In the above-described embodiment, the printing application 1100 is operated on the computer 1000. However, the printing application 1100 may be operated on the printer 2000 to execute conversion processing through chatting. In this case, through the processing for initially opening the printing application 1100, a print job is selected from a print job list for reservation printing or a job history screen displaying printing jobs provided by the printer 2000, and the printing application 1100 is started by using that print job as the print data.

According to the present disclosure, it is possible to reduce time and effort necessary to restore an image to the image edited at a certain point, in a case where editing work is repeatedly performed on the input image based on a prompt input by the user.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-176791, filed October 8, 2024, which is hereby incorporated by reference herein in its entirety.

What is claimed is:

1. A non-transitory computer readable storage medium storing a program for causing an information processing apparatus to perform a method, the method comprising:
displaying a first image in a first display area, the first image being generated based on a first prompt input by a user and an image of input image data;
displaying histories associated with the first image in a second display area in a state where a second image generated based on a second prompt input by the user and the generated first image is displayed in the first display area; and
transmitting print data including image data of an image displayed in the first display area to a printing apparatus via print data transmission by accepting a printing instruction,
wherein the first image is displayed in the first display area when a history associated with the first image is selected from the displayed histories in a state where the second image is displayed in the first display area.

2. The non-transitory computer readable storage medium according to claim 1,
wherein the program further causes the information processing apparatus to accept an input of a prompt from the user, and
wherein the first prompt is a prompt whose input is accepted earlier than an input of the second prompt.

3. The non-transitory computer readable storage medium according to claim 1,
wherein the program further causes the information processing apparatus to:
transmit the input first prompt and the input image data to a generative artificial intelligence (AI) server; and
receive, from the AI server, image data of the first image generated based on the transmitted input prompt and the transmitted input image data,
wherein the first image of the received image data is displayed in the first display area during image display.

4. The non-transitory computer readable storage medium according to claim 1,
wherein the program further causes the information processing apparatus to accept a print setting through setting acceptance, and
wherein the print data including the print setting is transmitted to the printing apparatus through the print data transmission.

5. The non-transitory computer readable storage medium according to claim 1, wherein the histories include the input image and the first image.

6. The non-transitory computer readable storage medium according to claim 5, wherein the input image, the first image, and the first prompt are displayed in the second display area through the history display.

7. The non-transitory computer readable storage medium according to claim 1, wherein the first display area is a preview area.

8. The non-transitory computer readable storage medium according to claim 1, wherein the histories are displayed in chronological order in the second display area.

9. An information processing apparatus comprising:
at least one memory storing instructions; and
at least one processor that, upon execution of the stored instructions, configures the at least one processor to operate as:
an image display unit configured to display a first image in a first display area, the first image being generated based on a first prompt input by a user and an image of input image data;
a history display unit configured to display histories associated with the first image in a second display area, in a state where a second image generated based on a second prompt input by the user and the generated first image is displayed in the first display area; and
a print data transmission unit configured to transmit print data including image data of an image displayed in the first display area to a printing apparatus by accepting a printing instruction,
wherein the image display unit displays the first image in the first display area, when a history associated with the first image is selected from the displayed histories in a state where the second image is displayed in the first display area.

10. The information processing apparatus according to claim 9,
wherein the at least one processor further operates as an acceptance unit configured to accept an input of a prompt from the user, and
wherein the first prompt is a prompt whose input is accepted earlier than an input of the second prompt.

11. The information processing apparatus according to claim 9, wherein the at least one processor further operates as:
a transmission unit configured to transmit the input first prompt and the input image data to a generative AI server; and
a receiving unit configured to receive, from the AI server, image data of the first image generated based on the transmitted input prompt and the transmitted input image data, and
wherein the image display unit displays the first image of the received image data in the first display area.

12. The information processing apparatus according to claim 9,
wherein the at least one processor further operates as a setting acceptance unit configured to accept a print setting, and
wherein the print data transmission unit transmits the print data including the print setting to the printing apparatus.

13. The information processing apparatus according to claim 9, wherein the histories include the input image and the first image.

14. The information processing apparatus according to claim 13, wherein the history display unit displays the input image, the first image, and the first prompt in the second display area.

15. The information processing apparatus according to claim 9, wherein the first display area is a preview area.

16. The information processing apparatus according to claim 9, wherein the histories are displayed in chronological order in the second display area.

17. An information processing method comprising:
displaying a first image in a first display area, the first image being generated based on a first prompt input by a user and an image of input image data;
displaying histories associated with the first image in a second display area, in a state where a second image generated based on a second prompt input by the user and the generated first image is displayed in the first display area; and
transmitting print data including image data of an image displayed in the first display area to a printing apparatus via print data transmission by accepting a printing instruction,
wherein the first image is displayed in the first display area, when a history associated with the first image is selected from the displayed histories in a state where the second image is displayed in the first display area.
